(19) United States
(12) Patent Application Publication
(10) Pub. No.: US 2012/0246562 A1
(43) Pub. Date: Sep. 27, 2012

(54) BUILDING A CUSTOMIZED STORY

(76) Inventors: Leslie Gable Maness, Bonner Springs, KS (US); Lee Ann Franklin, Overland Park, KS (US); David Morgan Lewis, Overland Park, KS (US); David Galen Saville, Shawnee, KS (US); Kirby Bouas McDaniel, Parkville, MO (US); Maria Jean Brenny, Mission, KS (US)

(21) Appl. No.: 13/072,317

(22) Filed: Mar. 25, 2011

(51) Int. Cl. G06F 17/24

(52) U.S. Cl. 715/256

(57) ABSTRACT

Methods, systems, and computer-readable media for a method of building a customized story are provided. A user may select the story topic (e.g., grandparent memories, parent memories, vacation memories) they would like to use to build the story. The user selects story elements (chapters/subheadings) that are applicable to their personal story. The user is able to customize these story elements and add their own memory content and personalized data. It results in a story (both narrative & visual) that includes both base content and user content, merged into a single compelling story.

### BACKGROUND

People have various forms of memory content (e.g., digital photographs, videos, journal pages, handwritten notes, physical artifacts, mementos, clip art). In many cases they desire to assemble the memory content in a way that tells a personal story, either for their own keeping or for giving & sharing with others. The assembled content has value to people who wish to remember meaningful moments, events, and people in their lives. The forms in which people assemble memory content has changed with technology. Some people make physical scrapbooks, some make digital photo-books, some make “slideshows.”

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the present invention are generally directed to a method of building a customized story. A user may select the story topic (e.g., grandparent memories, parent memories, vacation memories) they would like to use to build the story. The user also selects story elements (chapters/subheadings) that are applicable to their personal story. The user is able to customize these story elements and add their own memory content and personalized data. This combination results in a story (both narrative & visual) that includes both base content and user content, merged into a single compelling story. This story may be delivered in various formats: e.g. a tangible, bound printed book, a video slide-show, a multi-media file. Through embodiments of the present invention, a user can construct a uniquely personal story that exceeds the outcome he/she would have achieved on his/her own.

### BRIEF DESCRIPTION OF THE DRAWINGS

Embodiments of the invention are described in detail below with reference to the attached drawing figures, wherein:

FIG. 1 is a block diagram of an exemplary computing environment suitable for implementing embodiments of the invention;

FIG. 2 is a diagram of a storyline interface that allows a user to select a customized storyline, in accordance with an embodiment of the present invention;

FIG. 3 is a diagram of a preliminary-details interface that allows a user to provide information that is used to customize the storyline to a specific person, in accordance with an embodiment of the present invention;

FIG. 4 is a diagram of a story-element interface that allows a user to select story elements for inclusion in the customized story, in accordance with an embodiment of the present invention;

FIG. 5 is a further diagram of a story-element interface that allows a user to select story elements for inclusion in the customized story, in accordance with an embodiment of the present invention;

FIG. 6 is a diagram of an element-customization interface that allows a user to customize a story element, in accordance with an embodiment of the present invention;

FIG. 7 is a further diagram of a element-customization interface that allows a user to customize a story element with an example customization illustrated, in accordance with an embodiment of the present invention;

FIG. 8 is a diagram of a element-customization interface that allows a user to customize a story element with an another example customization illustrated, in accordance with an embodiment of the present invention;

FIG. 9 is a diagram of a element-customization interface that allows a user to customize a story element with a further example customization illustrated, in accordance with an embodiment of the present invention;

FIG. 10 is a diagram of a story-editing interface that allows a user to customize a draft story built using a combination of story elements, in accordance with an embodiment of the present invention;

FIG. 11 is a diagram of a design interface that allows a user to further customize the story by selecting a theme, in accordance with an embodiment of the present invention;

FIG. 12 is a diagram of a memory content interface that allows a user to further customize the story by adding memory content and captions to the story, in accordance with an embodiment of the present invention;

FIG. 13 is a diagram of a completed-story interface that allows a user to customize a storyline that comprises user provided pictures, a selected theme, and the draft story, in accordance with an embodiment of the present invention;

FIG. 14 is a flow diagram illustrating a method for building a customized story, in accordance with an embodiment of the present invention;

FIG. 15 is a flow diagram illustrating a method for building a customized story, in accordance with an embodiment of the present invention; and

FIG. 16 is a flow diagram illustrating a method for building a customized story, in accordance with an embodiment of the present invention.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are generally directed to a method of building a customized story. A user may select the story topic (e.g., grandparent memories, parent memories, vacation memories) they would like to use to build the story through a series of user interfaces. The user selects story elements (chapters/subheadings) that are applicable to their personal story. The user is able to customize these story elements and add their own memory content and personalized data. This combination results in a story (both narrative & visual) that includes both provided and user content, merged into a single compelling story. This story may then be delivered in various formats: e.g. a tangible bound printed book, a video slide-show, a multi-media file, etc. Through embodiments of the present invention, a user can construct a uniquely personal story that exceeds the outcome he/she would have achieved on his/her own.

Having briefly described an overview of embodiments of the invention, an exemplary operating environment suitable for use in implementing embodiments of the invention is described below.

### Exemplary Operating Environment

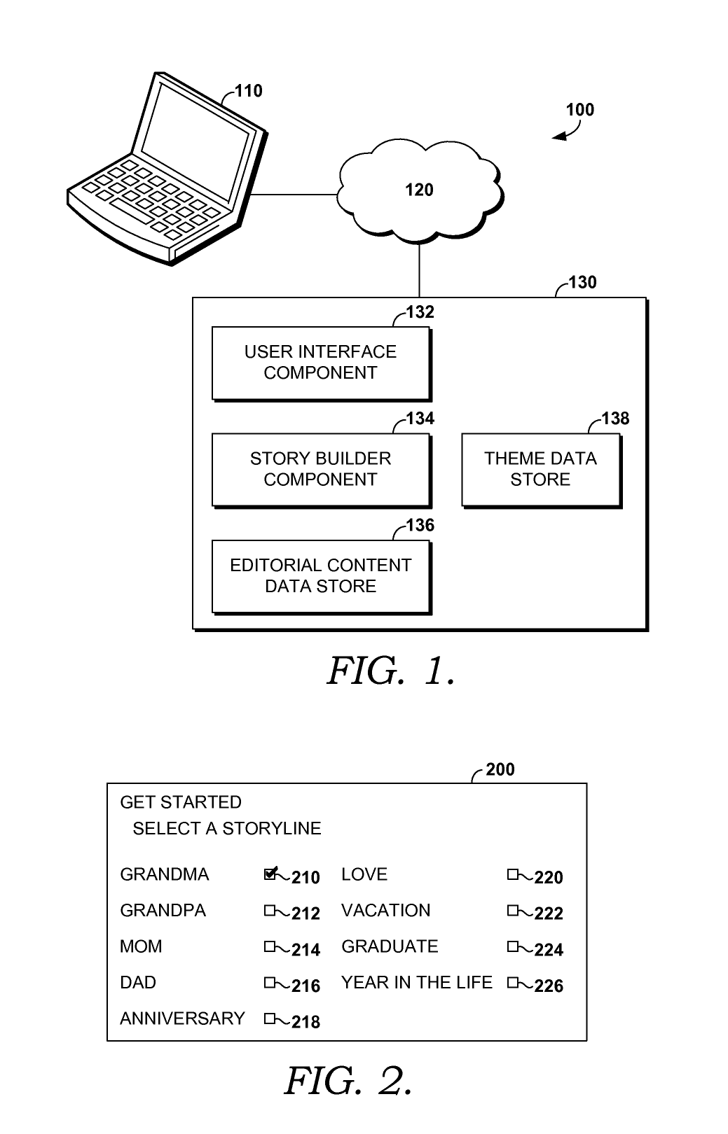

Referring to the drawings in general, and initially to FIG. 1 in particular, an exemplary computing environment for implementing embodiments of the invention is shown and designated generally as computing environment 100. Computing environment 100 is but one example of a suitable computing environment and is not intended to suggest any limitation as to the scope of use or functionality of the invention. Neither should the computing environment 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implements particular abstract data types. Embodiments of the invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

Computing environment 100 typically includes a variety of computer-readable storage media. By way of example, computer-storage media may comprise Random Access Memory (RAM); Read Only Memory (ROM); Electronically Erasable Programmable Read Only Memory (EEPROM); flash memory or other memory technologies; Compact Disk Read-Only Memory (CDROM), digital versatile disks (DVDs) or other optical or holographic media; magnetic cassettes, magnetic tape, magnetic disk storage or other magnetic storage devices; or any other medium that can be used to encode desired information and be accessed by a computing device. The computer-readable storage media may be non-transitory.

The computing environment 100 includes a computing device 110, a network 120, and a story-builder engine 130. The computing device 110 may include computer-storage media, a power source, a processor, one or more input devices (e.g., keyboard, mouse, touchpad, a touch screen, etc.) input/output ports, and a network interface. The network interface may be wired or wireless. While depicted in FIG. 1 as a laptop computer, computing device 110 could be a desktop computer, a server, PDA, smart-phone, tablet p.c., digital reading device, or other computing device. Distinction is not made between such categories as “workstation,” “server,” “laptop,” “handheld device,” etc., as all are contemplated within the scope of FIG. 1 and reference to “computer” or “computing device.” The computing device 110 is communicatively coupled to the network 120.

The network 120 might include a wireless network, landline, cable line, digital subscriber line (DSL), fiber-optic line, local area network (LAN), wide area network (WAN), metropolitan area network (MAN), or the like. Network 120 is not limited, however, to connections coupling separate computer units. Rather, network 120 can comprise subsystems that transfer data between servers or computing devices. For example, network 120 may also include a point-to-point connection, the Internet, an electrical bus, a neural network, or other internal system. The network 120 is communicatively coupled to the story-builder engine 130.

The story-builder engine 130 builds a customized story for the user. The story-builder engine 130 may operate in a distributed computing environment or on a single computing device. The story-builder engine 130 is communicatively coupled to the computing device 110, through network 120. The story-builder engine 130 includes user-interface component 132, story-builder component 134, editorial-content data store 136, and theme data store 138.

The user-interface component 132 generates user interfaces that allow a user to build a customized story. Once generated, the user interfaces may be communicated to the computing device 110 through the network 120. The computing device 110 may then display an interface on a computer screen. In one embodiment, the user interface is displayed as a web page in a web browser. Other types of user interfaces are possible. Examples of user interfaces are explained in more detail with reference to FIGS. 2-13.

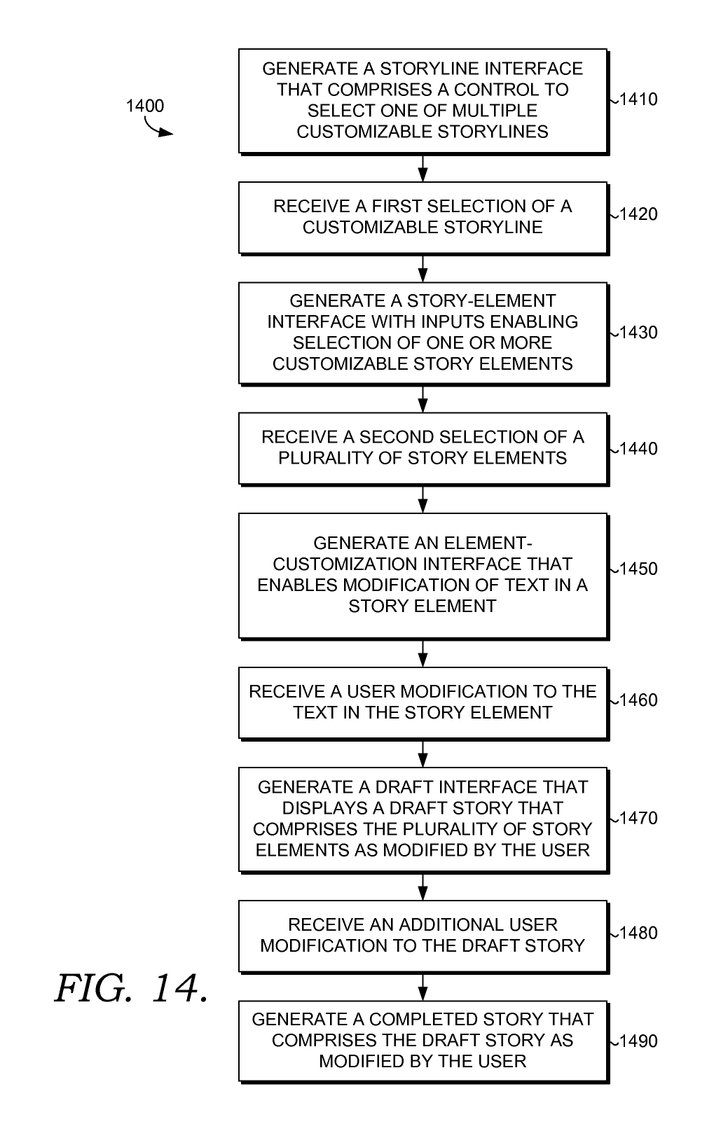

The story-builder component 134 builds a customized story for the user based on input received through the user-interface component 132 and editorial content and theme data stored in the story-builder engine 130. The editorial-content data store 136 stores text elements associated with storylines. The story-builder component 134 may retrieve relevant story elements from the editorial-content data store 136 and modify the story element as input is received from a user. The theme data may be stored in the theme data store 138. Theme data includes page templates, colors schemes, design graphics, and other appearance characteristics of a customized story. Additional functions of the story-builder component 134 will be explained in greater detail with reference to the interfaces shown in FIGS. 2-13 and the flow charts shown in FIGS. 14-16.

Turning now to FIG. 2, a diagram of a storyline interface 200 that allows the user to select a customized storyline is shown, in accordance with an embodiment of the present invention. The storyline interface 200 includes several storylines from which a user may begin building a customized story. Each storyline is designed to tell a story about a person, event, or place associated with the user's memories. The storylines shown on storyline interface 200 include a grandma storyline 210, a grandpa storyline 212, a mom storyline 214, a dad storyline 216, an anniversary storyline 218, a love storyline 220, a vacation storyline 222, a graduate storyline 224, and a year-in-the-life storyline 226. As can be seen, the grandma storyline 210 has been selected by the user in FIG. 2 by selecting the box adjacent to the description of the grandma storyline 210. Subsequent examples shown in this application are based on the grandma storyline.

The grandma storyline 210 tells a story about a child's experiences with grandma. The grandpa storyline 212 may be similar. The mom storyline 214 tells a story about a child's experiences with their mom. The dad storyline 216 tells a story about a child's experiences with their dad. The anniversary storyline 218 tells a story about a user's memories with a significant other. The love storyline 220 tells a story about a loved one. The vacation storyline 222 tells a story about a vacation. The graduate storyline 224 captures memories for a graduating student. For example, the graduate storyline 224 may tell a story highlighting a graduate's experiences during high school. The year-in-the-life storyline 226 tells a story featuring highlights for the year. Embodiments of the present invention are not limited to the storylines shown. Further, storylines at a lower level of granularity could be presented. For example, a high school graduate storyline or a college graduate storyline could be presented in addition to, or instead of, the more generic graduate storyline 224. Similarly, mountain vacation, beach vacation, cruise vacation, or European vacation storylines could be presented instead of a generic vacation storyline 222.

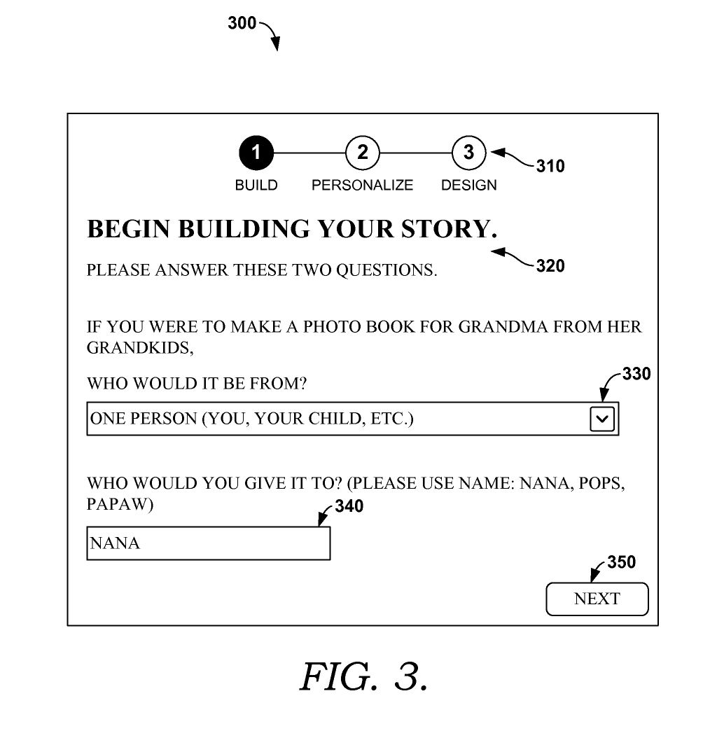

Turning now to FIG. 3, a preliminary-details interface that allows a user to provide information for customizing the storyline to a specific person is shown, in accordance with an embodiment of the present invention. The preliminary-details interface 300 may be shown after the user selects a storyline. The preliminary-details interface 300 includes a progress update 310 that changes as the user moves through the story customization process. The progress update 310 communicates that the user is in Phase I of “building their story.”

The preliminary-details interface 300 also includes instructions 320 for the user. The instructions 320 ask the user to answer two questions. The first question asks the user who the customized story will be from. A dropdown menu 330 allows the user to select from one or more options. In one embodiment, answering who the story is from does not require specifying a particular person. Answering whether the story is from one person or a group of people may be sufficient. Depending on the answer, the text in the story will be updated to make language in the story grammatically correct. In the example shown, the dropdown menu 330 indicates that the user has selected one person. Subsequent examples will be based on this selection, but embodiments of the present invention are not limited to text that is customized to be from a single person. In other embodiments, the name of a particular person or a group of people, or multiple names may be provided through the preliminary-details user interface 300 and included in the customized story.

The second question asks, “Who would you give it to?” A textbox 340 is provided for the user to type in the name of the recipient. In this example, the user has typed in “Nana,” which is a nick-name for grandma. Upon answering the questions, the user may click the “next” button 350 to move on to a subsequent interface.

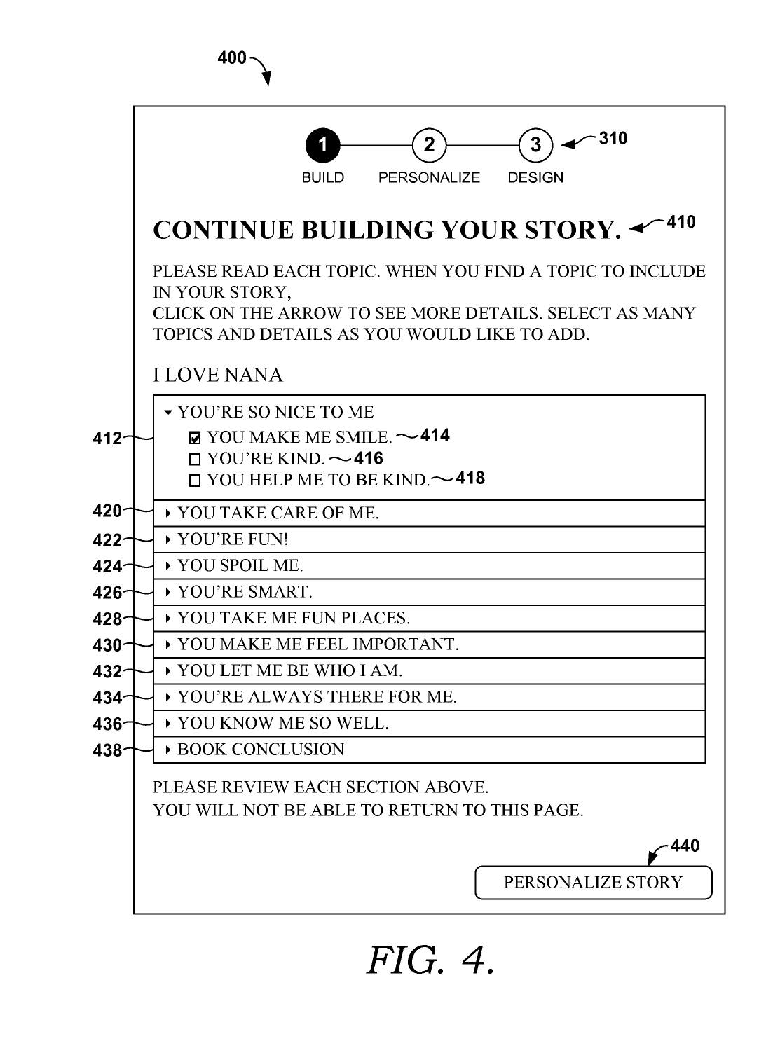

Turning now to FIG. 4, a story-element interface 400 that allows the user to select story elements for inclusion in the customized story is shown, in accordance with an embodiment of the present invention. The story-element interface 400 includes the progress update 310 and instructions 410. The instructions ask the user to select story elements to include in the story. The story elements are divided into topics. Under each topic one or more story elements may be selected.

Exemplary topics shown on the story-element interface 400 include the “you're so nice to me” topic 412, the “you take care of me” topic 420, the “you're fun” topic 422, the “you spoil me” topic 424, the “you're smart” topic 426, the “you take me fun places” topic 428, the “you make me feel important” topic 430, the “you let me be who I am” topic 432, the “you're always there for me” topic 434, the “you know me so well” topic 436, and the “book conclusion” topic 438. As mentioned, upon selecting a topic, story elements associated with the topic are shown. Exemplary story elements under topic 412 include the “you make me smile” story element 414, the “you're kind” story element 416, and the “you help me to be kind” story element 418. The “you make me smile” story element 414 has been selected. The user may select any story elements under a topic they would like to include in their customized story. The user does not need to select any story elements under a topic if they do not want them to be included. Once the user has made their selections they may click on the personalized story 440 button which will take them to the next part of the story customization process.

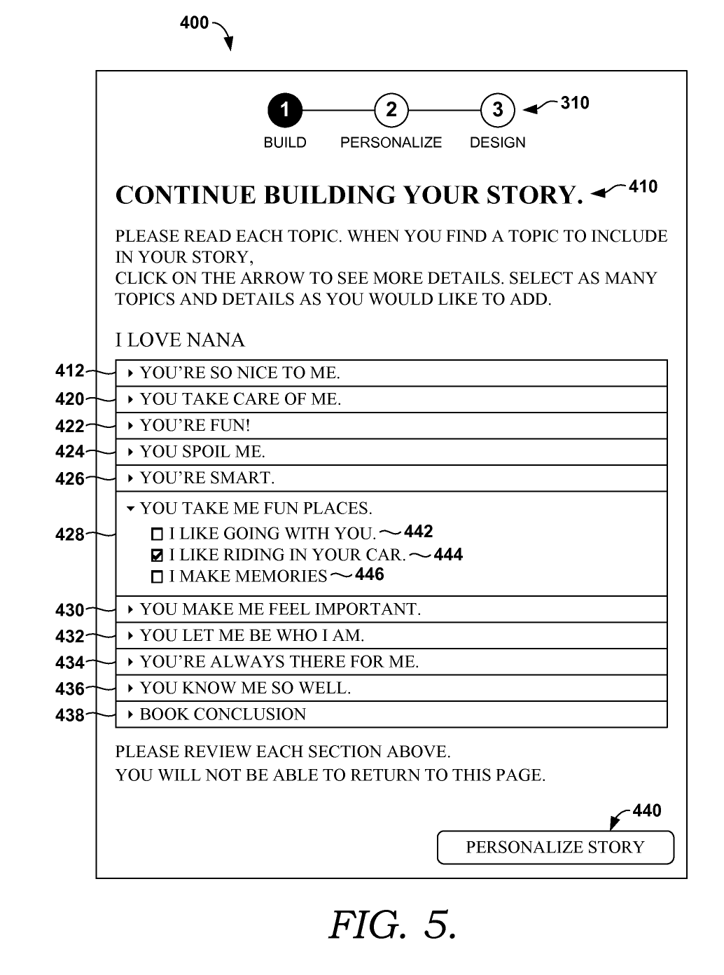

Turning now to FIG. 5, the story-element interface 400 is shown again with a different topic selected. The story-element interface 400 in FIG. 5, differs from the one described in FIG. 4 in that the “you take me fun places” topic 428 has been selected by the user rather than the “you're so nice to me” topic 412. Exemplary story elements shown under the “you take me fun places” topic 428 include the “I like going with you” story element 442, the “I like riding in your car” story element 444, and the “I make memories” story element 446. As can be seen, the “I like riding in your car” story element 444 has been selected for inclusion in the user's customized story.

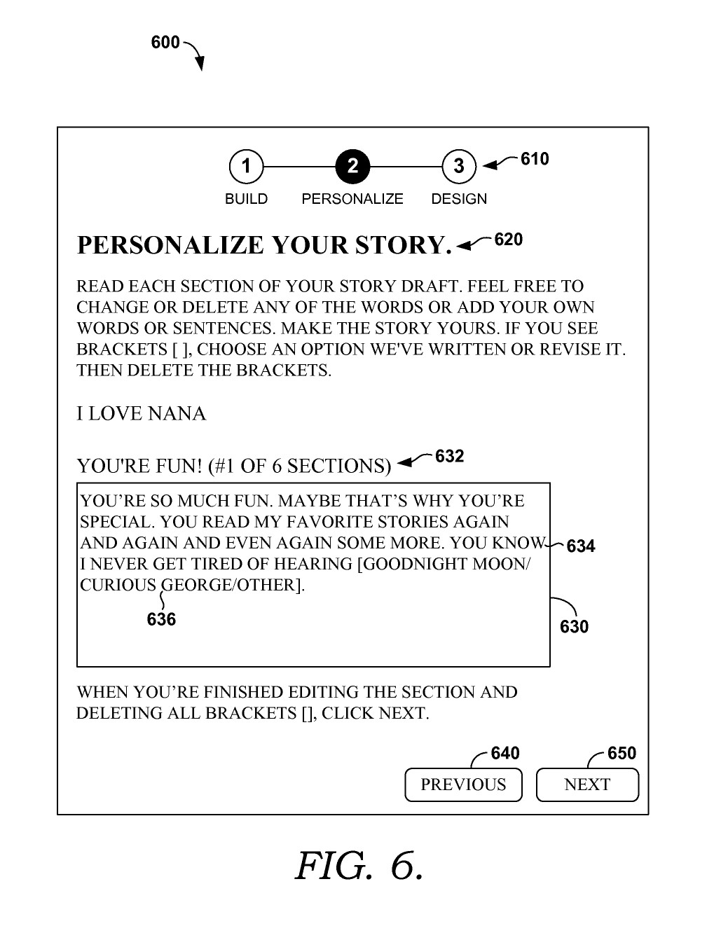

Turning now to FIG. 6, an element-customization interface 600 that enables modification of text in a story element is shown, in accordance with an embodiment of the present invention. The element-customization interface 600 includes a progress update 610. The progress update 610 indicates that the user has moved on to the personalize step. The element-customization interface 600 includes instructions 620 that ask the user to customize the text shown in text editor 630. The element-customization interface 600 displays a story element for editing or personalization. As can be seen by the label, this is the first of six story elements 632. The user is especially encouraged to edit the bracketed text 636. In addition to brackets, the bracketed text 636 may be of a different color, font, boldness, in italics, or otherwise standout. In one embodiment, an error message is presented if the user selects the “next” button 650 without modifying the bracketed text 636 and deleting the brackets.

The story element includes narrative text 634 and bracketed text 636. The user may edit any portion of the narrative text 634 or the bracketed text 636. The bracketed text 636 suggests various events. As used throughout the application an event may be a person, a place, a thing, or an event. In this case, the bracketed text 636 suggests the names of books that the child might read with their grandma. While the user could select one of the books suggested, the suggestions are primarily there to draw out personalized event information from the user. For example, in this case, the edits could include one of the child's favorite books that they frequently read together.

Once the user is satisfied with their edits, the user may select the “next” button 650 to take them to the next story element. If the user wishes to go back and edit a previous story element then the user may push the “previous” button 640. In this case, the user is on the first story element so pushing the “previous” button 640 would take them back to the preliminary-details interface 300 where they could provide different details. When either the “previous” button 640 or the “next” button 650 is selected, any changes made to the story element may be saved. Each time the user navigates back to the particular story element, the most recent version of their story element is displayed to them. In one embodiment, an additional button is provided to allow the user to save the customized story as-is and come back to it later.

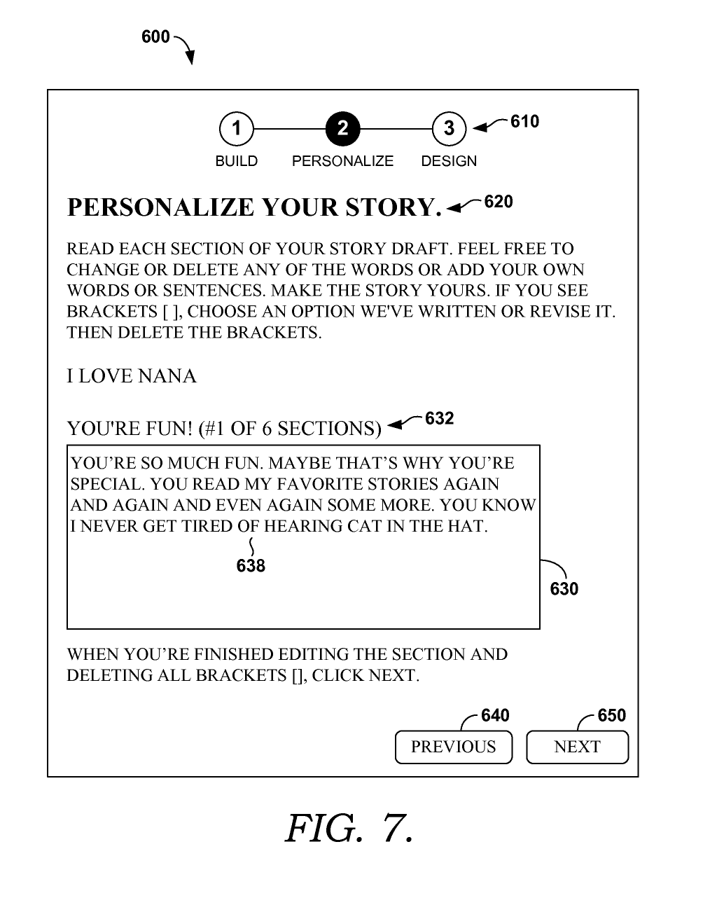

Turning now to FIG. 7, the element-customization interface 600 is shown with changes to the first story element. As can be seen, the user has entered their favorite book title to replace the bracketed text 638.

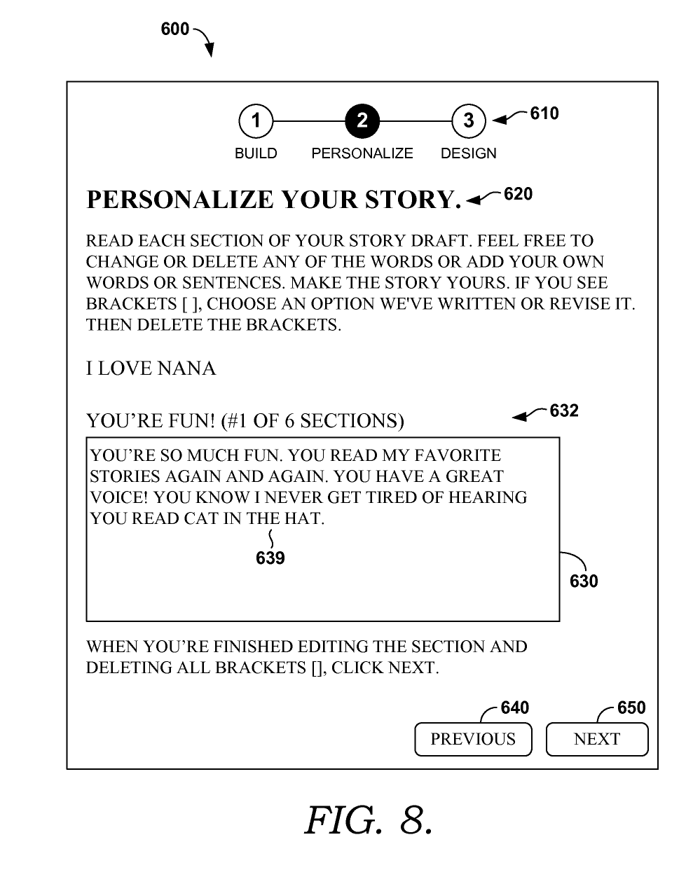

Turning now to FIG. 8, the element-customization interface 600 is shown with further edits to the text in the editor 630. The text 639 has been edited to delete “maybe that's why you're special” and add “you have a great voice.” This text 639 completes the personalization of the first story element.

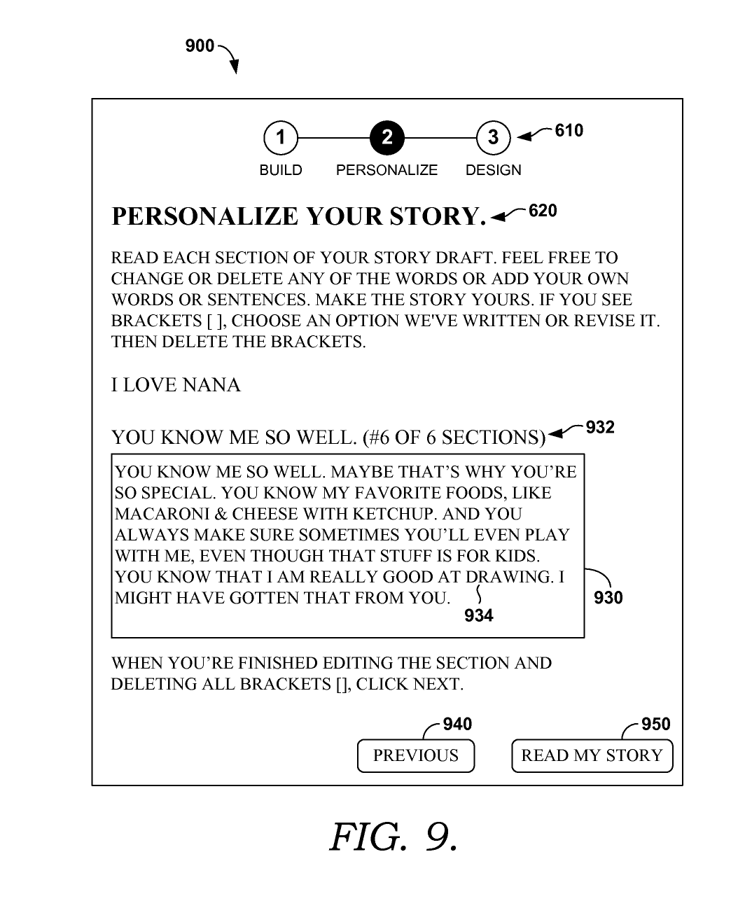

Turning now to FIG. 9, the element-customization interface 900 is shown with the sixth selected story element 932 shown in the text editor 930. The text 934 has been edited and actual event information has replaced suggested event information, which would have been presented in brackets (not shown in FIG. 9). Upon selecting the “read my story” 950 button, the user is taken to a story-editing interface 1000.

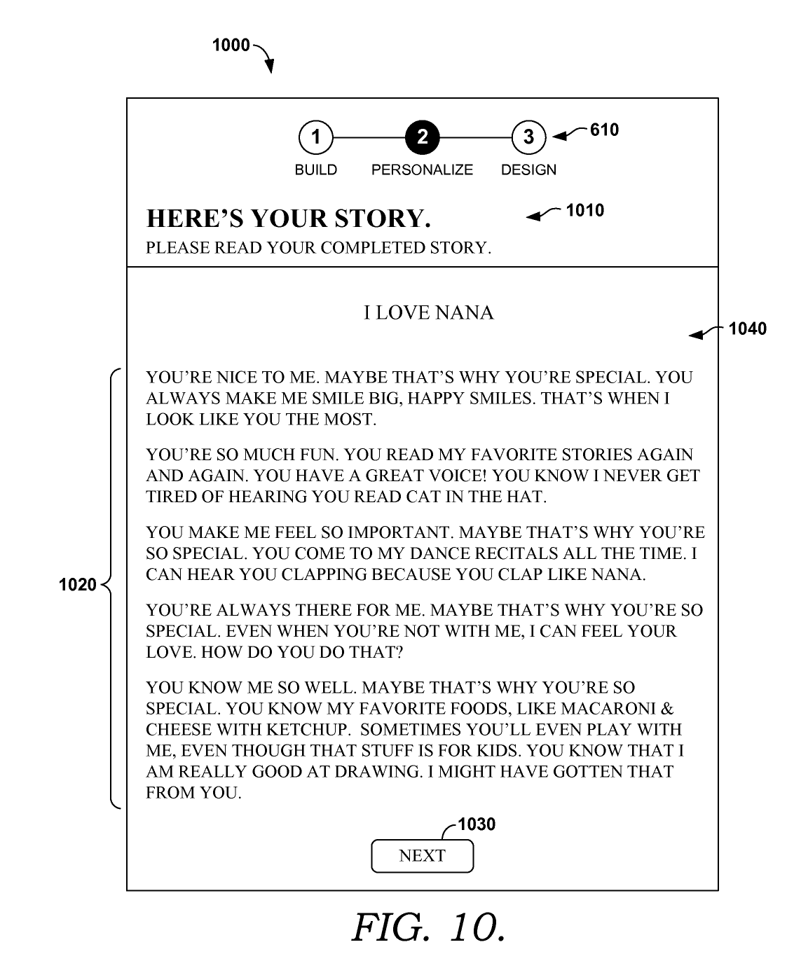

Turning now to FIG. 10, a story-editing interface 1000 is shown, in accordance with an embodiment of the present invention. The story-editing interface 1000 includes the progress update 610, and story-editing instructions 1010. The story-editing instructions 1010 encourage the user to read and edit their entire draft story 1020. The draft story 1020 is presented in a text-editing window 1040. The user may delete, add, or move text. The draft story 1020 is a compilation of the story elements as previously edited by the user. The user may have selected multiple story elements and had a chance to individually edit the story elements in the previous interfaces. Once the user is satisfied with their story, they may push the next button 1030 to continue the customization process.

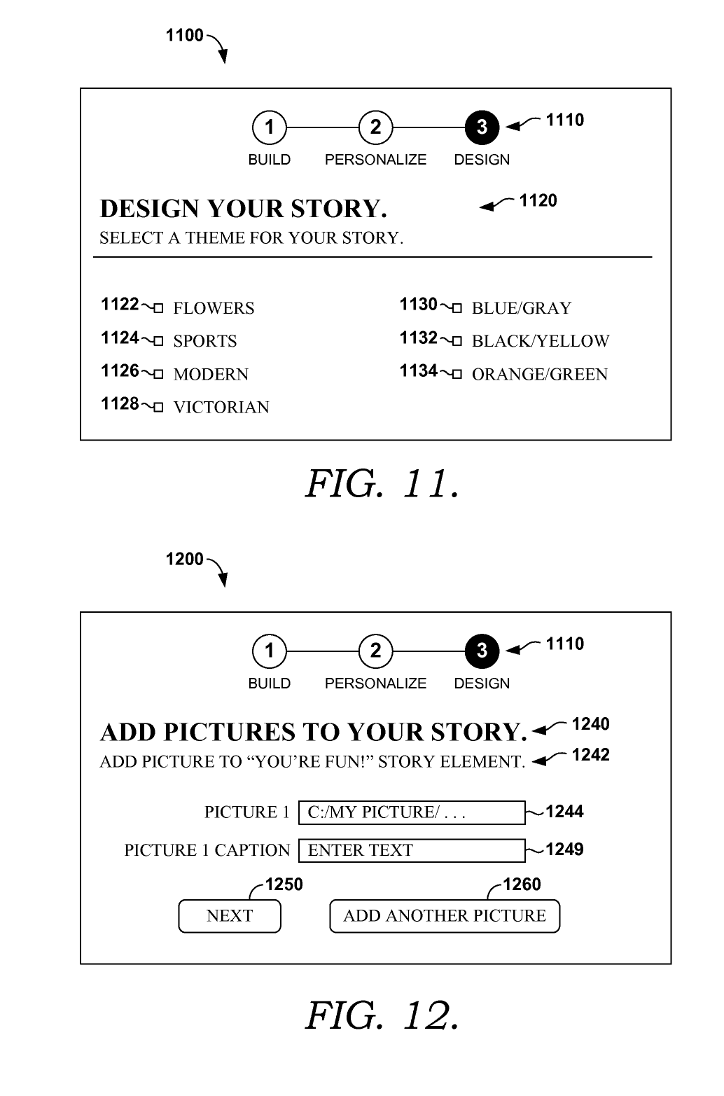

Turning now to FIG. 11, a design interface 1100 is shown, in accordance with an embodiment of the present invention. The design interface includes progress update 1110. The progress update 1110 indicates that the user has moved on to the design phase of the customized story-building process. The design interface 1100 includes instructions 1120. The instructions ask the user to select a theme for their story. Several exemplary themes are shown below the instructions. In the design interface 1100, a user may select a theme by checking the box next to the description of the theme. The themes shown include Flowers 1122, Sports 1124, Modern 1126, Victorian 1128, Blue/Gray 1130, Black/Yellow 1132, and Orange/Green 1134. In some cases, the themes may be combined to allow the user to select multiple themes. For example, the color themes 1130, 1132, 1134 may be combined with the other themes to create a uniform design. A selected theme may provide a background and templates into which the story and subsequently received memory content are combined.

Turning now to FIG. 12, a memory-content interface 1200 is shown, in accordance with an embodiment of the present invention. The memory-content interface 1200 allows a user to submit memory content (e.g., pictures, videos, and audio files) to be included in the customized story. As used throughout this application “memory content” could be a single item of memory content or multiple items of memory content. The memory-content interface 1200 includes instructions 1240 for the user. The memory-content interface 1200 displays the story element 1242 with which the memory content will be associated in the customized story. In this case, the memory content will be associated with the “you're fun!” story element 1242. The memory-content interface 1200 could be specialized to a particular kind of memory content such as pictures. For example, a different memory-content interface may be provided for each type of memory content. In another embodiment, a single memory content interface is provided that is adapted to receive multiple kinds of memory content through the same interface.

The memory-content interface 1200 includes a location bar 1244 where a user can navigate to stored memory content. The memory content could be stored on a computing device's hard drive, portable media, or on a remote computing device accessed over a network. For example, pictures could be retrieved from a social networking website, photo website, or other source. The user also has an option of entering a caption for the picture in text box 1249. The caption can be displayed adjacent to the picture within the customized story. When a user has completed adding the first picture, they can click the “add another picture” button 1260. Upon clicking the “add another picture” button 1260, the description on the memory-content interface 1200 will change to picture 2 and picture 2 caption. A user can then repeat the process just described with reference to picture 1. When the user has added all their memory content, they may click the “next” button 1250 to complete a draft of their customized story.

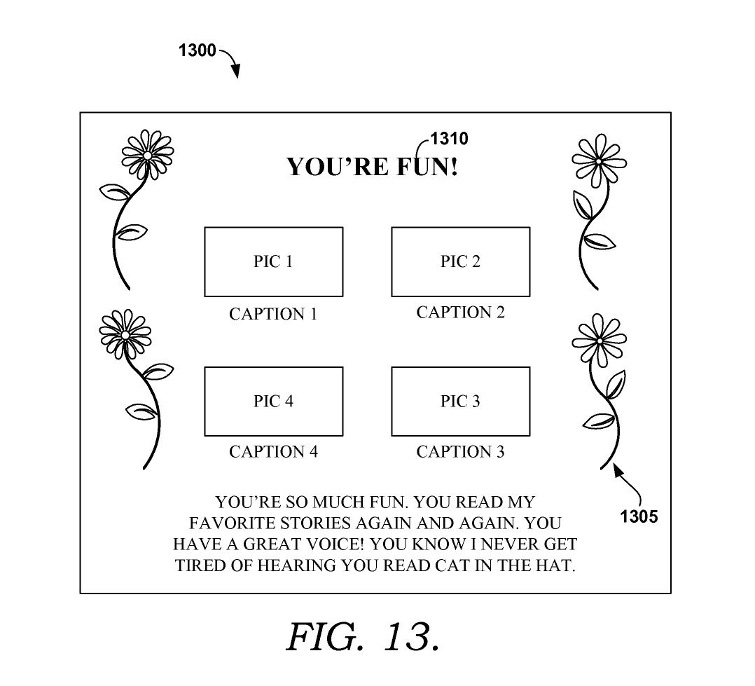

Turning now to FIG. 13, a completed-story interface 1300 is shown, in accordance with an embodiment of the present invention. The completed-story interface 1300 shows a draft of the completed customized story. In this example, a single page associated with the “you're fun!” 1310 story element is shown. The page shown includes design elements 1305 based on the selected theme. The page also includes pictures, picture captions and previously edited text. In one embodiment, the user could navigate through the completed story one page at a time. In one embodiment, the completed-story interface 1300 gives the user another opportunity to edit the story. For example, the user could update the text or move pictures and captions around or even delete pictures, captions, or theme elements. In the completed-story interface 1300 shown, the “you're fun!” story element 1310 is used as a title of the page. Embodiments of the present invention are not limited to including the title of a story element on a completed story. Once completed, the user may finalize the story and have it printed or built into an electronic book or slide show.

Turning now to FIG. 14, a method 1400 of building a customized story is shown, in accordance with an embodiment of the present invention. The customized story combines narrative content from a content provider with event data, memory content and narrative content provided by a user. The user has the opportunity to edit the content provided by the content provider as well as their own content multiple times throughout the method 1400. In one embodiment, a user accesses a computing system on which method 1400 is performed through a web-based interface. The user may need to provide login information and/or payment to initiate the method 1400.

At step 1410, a storyline interface is generated that comprises a control through which one of multiple customizable storylines are selected. In one embodiment, the control is a series of checkboxes displayed adjacent to descriptions of available storylines. The storyline interface may be similar to the storyline interface described previously with reference to FIG. 2. Other examples of controls are possible. For example, in one embodiment, storylines are selected through a dropdown menu.

At step 1420, a first selection of a customized storyline is received. The first selection may be received through the storyline interface generated at step 1410. In one embodiment, the first selection is passed from a user interface component to a story builder component, such as story-builder component 134 described previously with reference to FIG. 1. Once a storyline is selected, additional details about the storyline may be collected. For example, an interface may be provided to ask the name of a story recipient, a name of a story author, and/or other information about the story. Depending on this information, the storyline may be automatically edited, including making grammatical changes, to make the storyline conform to the information provided. The editing may occur automatically without user involvement before the storyline is presented to the user.

At step 1430, a story-element interface with inputs enabling selection of one or more customizable story elements is shown. The storyline selected at step 1410 may be associated with multiple story elements. In one embodiment, available story elements are presented in a hierarchal form separated by topic. A user may select topics of interest and then select story elements associated with that topic by navigating through the hierarchy. At step 1440, a second selection of a plurality of story elements is received. The story element selection may occur through the interface generated at step 1430.

At step 1450, an element-customization interface is generated. The element-customization interface allows a user to edit text in a story element. A story element may consist of a paragraph of text. The story element may be provided by the content provider with instructions to provide event information within the story element. As described previously, event information may describe a person, a place, a thing, or an event. The element customization interface may be similar to element-customization interface 600. At step 1460, a user modification to the text of the story element is received. A modification includes changing existing text, adding text, rearranging text, and other editing functions.

At step 1470, a story-editing interface is generated. The story-editing interface displays a draft story that comprises the plurality of story elements as modified by the user. The draft story is modifiable as displayed through the story-editing interface. The story-editing interface may be similar to story-editing interface 1000 described previously with reference to FIG. 10. At step 1480, an additional user modification to the draft story is received.

At step 1490, a completed story that comprises the draft story as modified by the user is generated. The completed story may also comprise memory content, such as pictures that were provided by the user. In addition, a user may select one or more themes or templates into which the customized story is incorporated. Once the completed story is generated, the completed story may be presented in a slide show, printed in a book, a webpage, or other presentation.

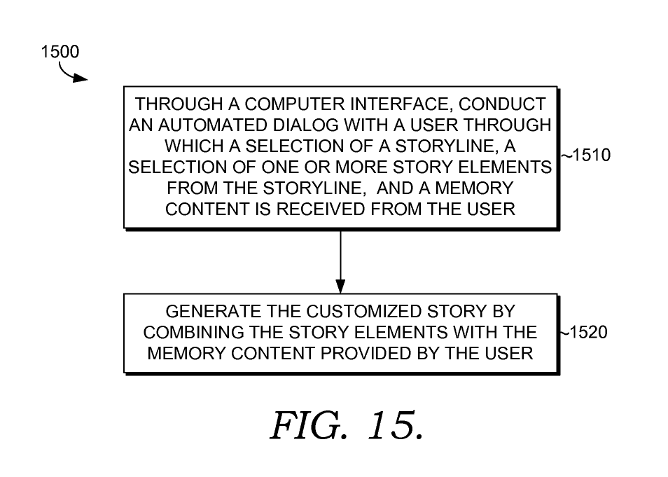

Turning now to FIG. 15, a method 1500 of building a customized story is shown, in accordance with an embodiment of the present invention. At step 1510, an automated dialogue is conducted with a user through a computer interface. During the dialogue, the user selects the storyline, selects a subset of story elements from the storyline, and provides memory content. During the dialog, the user may also modify text in the story elements individually through a text-editing interface and modify a draft story comprised of the story elements previously modified by the user. As described previously, a story element may include a first portion of story narration and a second portion of event suggestions. The event suggestions may be the name of a book, a vacation location, a person, a favorite food, a place, a thing, an emotion, a desription, or an event, included to elicit equivalent event information from the user. As described previously, both the first portion and the second portion are modifiable by the user through a text-editing interface. The second portion may be distinguished from the first portion by a different appearance such as a different font color, font size, font, italics, bold, brackets or other distinguishing feature. The event suggestion text may provide example events that are of a type that are consistent with the narration, easily understood, but not likely to actually apply to a user, thereby encouraging the user to modify the second portion. In one embodiment, an error message is generated when the user attempts to continue the dialogue without first modifying the second portion, which includes the event information.

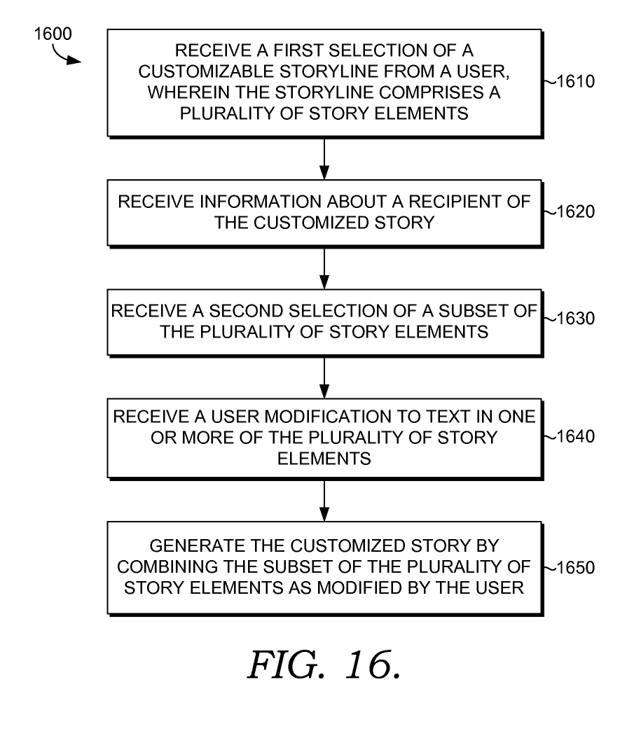

Turning now to FIG. 16, a method 1600 of building a customized story is shown, in accordance with an embodiment of the present invention. At step 1610, a first selection of a customized storyline is received from a user. The storyline comprises a plurality of story elements. In one embodiment, a first selection is received through an interface similar to storyline interface 200 described previously with reference to FIG. 2.

At step 1620, information about a recipient of the customized story is received. The information may be a name of the recipient, a number of recipients, or other demographic information associated with a recipient. Information about an author of the story may also be provided. Both the author and the recipient may be characters in the story. In an embodiment, the author is also the recipient of the story. In other words, the author generates the story for the author's use. In one embodiment, the information received is used to pre-customize the story before the user is given story element text to edit. This information may be used to edit the story so that it is grammatically consistent with the information provided. This editing may occur before any of the story elements are presented to the user.

At step 1630, a second selection of a subset of the plurality of story elements is received. The story elements may be selected through an interface similar to that described previously with reference to FIG. 4. A user may select all available story elements associated with the storyline or just a portion of the story elements associated with the storyline.

At step 1640, a user modification to text in one or more of the plurality of story elements is received. As described previously, the modification may be made in a text-editing window where the story element text is provided. As described previously, the text initially provided with the story element may include template event information that the user is encouraged or required to modify. Modifications to the rest of the text may be optional.

At step 1650, the customized story is generated by combining the subset of the plurality of story elements as modified by the user. The customized story may also include memory content, such as pictures provided by the user. A customized story may also be combined on templates consistent with a theme or design format selected by the user.

Embodiments of the invention have been described to be illustrative rather than restrictive. It will be understood that certain features and subcombinations are of utility and may be employed without reference to other features and subcombinations. This is contemplated by and is within the scope of the claims.

The invention claimed is:

1. One or more computer-readable storage media having computer-executable instructions embodied thereon that when executed by a computing device perform a method of building a customized story, the method comprising:
generating a storyline interface that includes a control to select one of multiple customizable storylines;
receiving a first selection of a customizable storyline;
generating a story-element interface with inputs enabling selection of one or more customizable story elements;
receiving a second selection of a plurality of customizable story elements;
generating an element-customization interface that enables modification of text in a story element;
receiving one or more user modifications to the text in the story element;
generating a story-editing interface that displays a draft story that includes the plurality of story elements as modified by a user, wherein the draft story is further modifiable through the story-editing interface;
receiving one or more additional user modifications to the draft story; and
generating a completed story that includes the draft story as additionally modified by the user.

2. The media of claim 1, wherein the element-customization interface displays the text in a text-editing window, and wherein the one or more modifications include one or more of deleting text, adding text, and moving text.

3. The media of claim 1, wherein the text in the story element includes a first portion of story narration and a second portion with one or more event suggestions, wherein both the first portion and the second portion are modifiable by the user.

4. The media of claim 3, wherein the second portion is distinguished from the first portion by a different appearance.

5. The media of claim 1, wherein the method further comprises receiving a memory content, wherein the memory content is associated with one of the plurality of customizable story elements, and wherein the completed story further includes the memory content.

6. The media of claim 1, wherein the method further comprises receiving a selection of a theme and wherein the completed story incorporates the theme.

7. The media of claim 1, wherein the completed story is presented in an interface through which the user may directly modify aspects of the completed story.

8. A method of building a customized story, the method comprising:
through a computer interface, conducting an automated dialog with a user through which the following is received from the user:
a selection of a storyline,
a selection of one or more story elements from the storyline, and
a memory content; and
generating the customized story by combining the one or more story elements with the memory content provided by the user.

9. The method of claim 8, wherein a text in a story element includes a first portion of story narration and a second portion of one or more event suggestions, and wherein both the first portion and the second portion are modifiable by the user through a text editing interface.

10. The method of claim 9, wherein the second portion is distinguished from the first portion by a different appearance.

11. The method of claim 10, wherein the second portion's text provides an example event that is consistent with the customized story's narrative.

12. The method of claim 8, wherein the method further comprises receiving one or more text modifications to the one or more story elements through a text editing interface and receiving one or more further modifications to a draft story comprised of the one or more story elements previously modified by the user.

13. The method of claim 8, wherein the automated dialog further includes the user specifying one or more recipients of the customized story, and wherein text in the one or more story elements is automatically customized to the one or more recipients prior to initially presenting the text to the user.

14. The method of claim 8, wherein the method further comprises receiving one or more further modifications to the customized story from the user.

15. One or more computer-readable storage media having computer-executable instructions embodied thereon that when executed by a computing device perform a method of building a customized story, the method comprising:
receiving a first selection of a customized storyline from a user, wherein the customized storyline includes a plurality of story elements;
receiving information about one or more recipients of the customized story;
receiving a second selection of a subset of the plurality of story elements;
receiving one or more user modifications to text in one or more of the plurality of story elements; and
generating the customized story by combining the subset of the plurality of story elements as modified by the user.

16. The media of claim 15, wherein the method further includes receiving a memory content from the user, wherein the memory content is associated with one or more of the subset of the plurality of story elements and the memory content is included in the customized story.

17. The media of claim 16, wherein the method further includes receiving a caption from the user that is included in the customized story, wherein the caption describes the memory content with which the caption is associated.

18. The media of claim 15, wherein the text in a story element includes a first portion of story narration and a second portion of one or more event suggestions and wherein both the first portion and the second portion are modifiable by the user through a text editing interface.

19. The media of claim 18, wherein the second portion is distinguished from the first portion by a different appearance.

20. The media of claim 15, wherein the text in the one or more of the plurality of story elements is automatically adjusted to grammatically match the one or more recipients of the customized story.

21. The media of claim 15, wherein the method further comprises receiving information describing one or more authors of the customized story, and wherein the text in the one or more of the plurality of story elements is automatically adjusted to grammatically match the one or more authors of the customized story.
